(19) United States
(12) Patent Application Publication
(10) Pub. No.: US 2023/0298130 A1
(43) Pub. Date: Sep. 21, 2023

(54) REMOTE RENDERING SYSTEM, IMAGE PROCESSING METHOD, SERVER DEVICE, AND PROGRAM

(71) Applicant: Nippon Telegraph and Telephone Corporation, Tokyo (JP)

(72) Inventors: Shinya Tamaki, Tokyo (JP); Toshihito Fujiwara, Tokyo (JP); Tomohiro Taniguchi, Tokyo (JP)

(21) Appl. No.: 18/013,622

(22) PCT Filed: Jul. 3, 2020
(86) PCT No.: PCT/JP2020/026248

§ 371 Date: Dec. 29, 2022

(51) Int. Cl. G06T 1/60; G06F 3/14

(52) U.S. Cl. CPC G06T 1/60; G06F 3/14

(57) ABSTRACT

An object of the present disclosure is to provide a remote rendering system, an image processing method, a server device, and a program capable of efficiently performing pre-rendering, reducing a delay in displaying an image to a user, and reducing a deviation between a line-of-sight direction of the user and a rendered image. In order to achieve the above object, the remote rendering system according to the present disclosure includes a terminal having a sensor, and a server, the terminal transmitting information about a sensor state to the server, and the server transmitting a rendered image corresponding to the sensor state to the terminal, wherein the terminal transmits information about the current sensor state to the server, and the server predicts a plurality of possibilities of the sensor state to be expected in an immediate future based on the received information about the current sensor state, performs rendering corresponding to the predicted possibilities of the sensor state, and stores a plurality of the rendered images generated by the rendering.

### TECHNICAL FIELD

The present disclosure relates to a technique for compensating a time required for communication and rendering in a remote rendering system for streaming providing a game or a service such as artificial reality (AR) or virtual reality (VR), in which sensor or command information is transmitted from a terminal to a server, a result image corresponding to the information is rendered by the server, and an image is responded to the terminal, and is output to a screen of the terminal.

### BACKGROUND ART

In recent years, with the development of the cloud technology, the spread of high-speed communication environments, and the spread of smartphones and tablet terminals, streaming services that perform the image rendering process in applications such as games and 3D computer aided design (CAD) on the server to transmit images to terminals connected via a network have attracted attention. In the streaming service, it is possible to provide various applications without disposing a high-performance computer equipped with a graphics processing unit (GPU) in a local environment of a user. For example, it is considered that even an inexpensive and small terminal such as a smartphone can make a user to experience a high-quality virtual 3D space, and utilization for games and digital catalog services is expected.

Meanwhile, in a streaming service such as a game, an image of a camera viewpoint based on sensor information transmitted from a terminal is drawn by a server, and a delay (referred to as motion-to-photon latency or the like) until the image is displayed on a terminal screen greatly affects the perceived quality of the user. Specifically, in a case where a streaming service is provided via a network, network delay, an increase in encoding or decoding delay of video data, resource shortage of a remote server, or the like is inevitable as compared with a case where rendering is performed in a local environment (gaming personal computer (PC) or high-performance workstation).

Specifically, with respect to remote rendering of AR, VR service, or the like, when a deviation occurs between the user's line-of-sight direction and the rendered image, it is a cause of VR sickness, and thus it is important to reduce a delay that is a cause of the deviation.

### CITATION LIST

### Non Patent Literature

Non Patent Literature 1: Daia, Xuefeng, Hanjiang Xionga, and Xianwei Zhenga. “A Cache Design Method For Spatial Information Visualization In 3D Real-Time Rendering Engine.” International Archives of the Photogrammetry, Remote Sensing and Spatial Information Sciences 39 (2012): B2
Non Patent Literature 2: “Head and Body Motion Prediction to Enable Mobile VR Experiences with Low Latency” December 2019, California University, Samsung
Non Patent Literature 3: “Furion: Engineering High-Quality Immersive Virtual Reality on Today's Mobile Devices” October 2017, Purdue University, and the like
Non Patent Literature 4: “FlashBack: Immersive Virtual Reality on Mobile Devices via Rendering Memoization” June 2016, Microsoft Research, et al.

### SUMMARY OF INVENTION

### Technical Problem

In related art, a method for reducing time required for rendering includes streaming pre-rendered images (for example, Non Patent Literature 1). By reading an image corresponding to the user's viewpoint from a memory region in which the image is previously drawn and stored, the time required for the rendering process can be deleted.

However, the pre-rendering method of Non Patent Literature 1 has the following problems. In the pre-rendering method, rendering is performed assuming all user's viewpoints, and thus there is a problem that enormous processing time is required. In addition, there is also a problem that re-rendering is required to be performed again over the same time when a design change or the like occurs. Further, there is also a problem that enormous storage is required to store all pre-rendered images. In addition, there is also a problem that the pre-rendering method cannot reduce a network delay or an encoding or decoding delay.

In order to solve the above problems, an object of the present invention is to provide a remote rendering system, an image processing method, a server device, and a program capable of efficiently performing pre-rendering, reducing a delay in displaying an image to a user, and reducing a deviation between a line-of-sight direction of the user and a rendered image.

### Solution to Problem

In order to achieve the above object, the remote rendering system of the present disclosure predicts a plurality of positions (coordinates) to be expected in the immediate future based on information about a sensor state from a terminal having a sensor, and renders an image in advance according to each predicted position.

Specifically, a remote rendering system according to the present disclosure includes a terminal having a sensor, and a server, the terminal transmitting information about a sensor state to the server, and the server transmitting a rendered image corresponding to the sensor state to the terminal, wherein the terminal transmits information about the current sensor state to the server, and the server predicts a plurality of possibilities of the sensor state to be expected in an immediate future based on the received information about the current sensor state, performs rendering corresponding to the predicted possibilities of the sensor state, and stores a plurality of the rendered images generated by the rendering.

In an image processing method according to the present disclosure in which a terminal having a sensor and a server are included, the terminal transmitting information about a sensor state to the server, and the server transmitting a rendered image corresponding to the sensor state to the terminal, the method includes: transmitting information about the current sensor state from the terminal to the server; predicting, by the server, a plurality of possibilities of the sensor state to be expected in an immediate future based on the received information about the current sensor state; performing rendering corresponding to the predicted possibilities of the sensor state; and storing a plurality of the rendered images generated by the rendering.

The remote rendering system and the image processing method according to the present disclosure can reduce a pre-rendering process and images generated by pre-rendering by pre-rendering an image only for positions (coordinates) to be expected in the immediate future. As a result, time and storage required for pre-rendering can be reduced. Furthermore, by storing the pre-rendered image, it is not necessary to sequentially perform the rendering process according to the current sensor state, and the rendering processing time can be reduced. Therefore, according to the present invention, it is possible to provide a remote rendering system and an image processing method capable of providing a remote rendering system, an image processing method, a server device, and a program capable of efficiently performing pre-rendering, reducing a delay in displaying an image to a user, and reducing a deviation between a user's line-of-sight direction and a rendered image.

A remote rendering system according to the present disclosure further includes an application management unit, wherein in a case where there is a plurality of the servers, the application management unit selects some of the plurality of servers and designates one of the selected servers as a master server and the others as slave servers, wherein the terminal transmits information about the current sensor state to the master server, the master server predicts a plurality of possibilities of the sensor state to be expected in an immediate future, and at least one of the master server and the slave servers performs the rendering based on the predicted possibilities of the sensor state, and stores the rendered image.

In the image processing method according to the present disclosure, the method includes: in a case where there is a plurality of the servers, selecting some of the plurality of servers, and designating one of the selected servers as a master server and others as slave servers; transmitting information about the current sensor state from the terminal to the master server; predicting, by the master server, a plurality of possibilities of the sensor state to be expected in an immediate future; and performing, by at least one of the master server and the slave servers, the rendering and storing the rendered image.

The remote rendering system and the image processing method according to the present disclosure can effectively utilize free resources of a plurality of servers by performing pre-rendering using the servers. In addition, by transmitting an image from a server in the vicinity of the terminal based on the position information about the terminal, a delay due to communication can be reduced.

In the remote rendering system according to the present disclosure, the server selects, from the plurality of stored rendered images, the rendered image corresponding to the current sensor state and transmits the selected rendered image to the terminal.

In the image processing method according to the present disclosure, the method includes: selecting, from the plurality of rendered images stored in the server, the rendered image corresponding to the current sensor state; and transmitting the selected rendered image to the terminal.

The remote rendering system and the image processing method according to the present disclosure can include transmitting a necessary image without performing the rendering process by selecting a pre-rendered image according to a current sensor state, so that it is possible to reduce a delay caused by the rendering process. Furthermore, in a case where a plurality of servers is used, a delay due to communication can be reduced by transmitting an image from a server in the vicinity of the terminal based on the position information about the terminal.

A server device according to the present disclosure is a server device that transmits, to a terminal having a sensor, a rendered image corresponding to the sensor state received from the terminal, wherein the server device includes a sensor information reception unit that receives information about the current sensor state from the terminal, a prediction unit that predicts a plurality of possibilities of the sensor state to be expected in an immediate future based on the received information about the current sensor state, a rendering unit that performs rendering corresponding to the predicted possibility of the sensor state, a storage unit that stores a plurality of the rendered images generated by the rendering, an image selection unit that selects the rendered image corresponding to the current sensor state from the plurality of rendered images stored in the storage unit, and an image transmission unit that transmits the selected rendered image to the terminal.

In the program according to the present disclosure, a computer is caused to function as the server device.

The server device and the program according to the present disclosure can reduce a pre-rendering process and images generated by pre-rendering by pre-rendering an image only for positions (coordinates) to be expected in the immediate future. As a result, time and storage required for pre-rendering can be reduced. Furthermore, by selecting a pre-rendered image according to the current sensor state, it is possible to transmit a necessary image without performing the rendering process, and thus, it is possible to reduce a delay due to the rendering process.

The above inventions can be combined as much as possible.

### Advantageous Effects of Invention

According to the present disclosure, it is possible to provide a remote rendering system, an image processing method, a server device, and a program capable of efficiently performing pre-rendering, reducing a delay in displaying an image to a user, and reducing a deviation between a line-of-sight direction of the user and a rendered image.

### BRIEF DESCRIPTION OF DRAWINGS

FIG. 1 is a diagram illustrating an outline of a remote rendering system according to the present invention.

FIG. 2 is a diagram illustrating an outline of a remote rendering system according to the present invention.

FIG. 3 is a diagram illustrating an outline of a remote rendering system according to the present invention.

FIG. 4 shows an example of a schematic configuration of a remote rendering system according to the present invention.

FIG. 5 illustrates an example of an image processing method of a remote rendering system according to the present invention.

FIG. 6 illustrates an example of an operation flow of a remote rendering system according to the present invention.

FIG. 7 shows an example of a schematic configuration of a remote rendering system according to the present invention.

FIG. 8 shows an example of a schematic configuration of a remote rendering system according to the present invention.

FIG. 9 illustrates an example of an image processing method of a remote rendering system according to the present invention.

### DESCRIPTION OF EMBODIMENTS

Hereinafter, embodiments of the present disclosure will be described in detail with reference to the drawings. Note that the present invention is not limited to the following embodiments. These examples are merely examples, and the present disclosure can be implemented in a form with various modifications and improvements based on the knowledge of those skilled in the art. Note that components having the same reference numerals in the present specification and the drawings indicate the same components.

### SUMMARY OF INVENTION

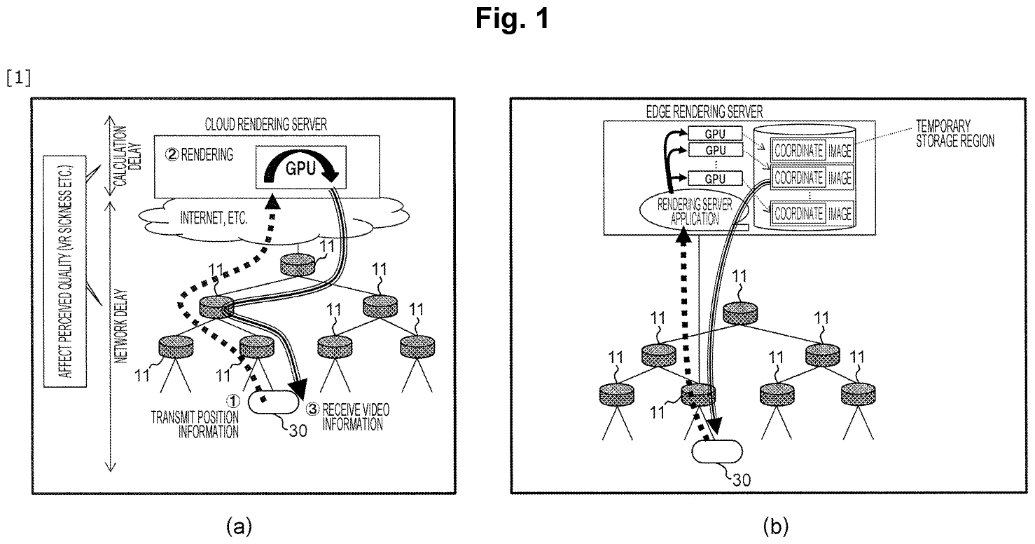

The summary of the present invention will be described with reference to FIGS. 1 to 3. In FIG. 1, (a) illustrates a conventional technique, and (b) illustrates the present invention.

In FIG. 1(a), a user terminal (for example, a head mounted display or the like) is connected to a cloud rendering server via a plurality of servers 11.

Hereinafter, the “user terminal” is abbreviated as a “terminal 30”. The terminal 30 transmits the position information acquired by the terminal 30 itself to the cloud rendering server via the plurality of servers 11. The cloud rendering server sequentially performs rendering by the GPU according to the position information. Then, the rendered image is displayed on the terminal via the plurality of servers 11 again. In the conventional technology, since rendering is sequentially performed according to the position information, time for the rendering process from when the terminal 30 transmits the position information to when an image corresponding to the position information is displayed on the terminal 30 is required, and a delay occurs. Furthermore, in order to acquire the rendered image, the terminal 30 is required to access the cloud rendering server via the plurality of servers 11, and thus, a communication distance is long and a network delay occurs. When these delays increase, the perceived quality of the user is adversely affected.

The summary of the present invention will be described with reference to FIG. 1(b). The present invention includes a plurality of servers 11, and selects one or a plurality of remote rendering edge servers or a server that caches a rendered image that is optimal according to an area where the terminal 30 exists, an allowable delay of an application, an available bandwidth of each network section, an edge server resource, or other network statuses. The remote rendering edge server and the server that caches the image may be the same or may be different. Hereinafter, “the remote rendering edge server or the server that caches the rendered image” is referred to as the “server 11”.

Each selected server 11 has a rendering server application. The rendering server application performs pre-rendering and image transmission. Pre-rendering and image transmission may be performed by only one server 11 or may be performed by a plurality of servers 11. Pre-rendering will be described. The terminal 30 transmits the position information (for example, head position information or the like of the head mounted display wearer) acquired by the terminal 30 itself to the selected server 11. The rendering server application of the server 11 that has received the position information predicts a plurality of positions (coordinates) to be expected in the immediate future according to the position information about the terminal 30. Further, the rendering server application of the selected server 11 performs rendering according to the predicted position to create an image, and stores the image in the temporary storage region. Furthermore, the image may be tactile information, auditory information, or the like.

Image transmission will be described. The terminal 30 transmits the position information acquired by the terminal 30 itself to the selected server 11. The selected server 11 calls an image corresponding to the received position information from the temporary storage region to transmit the image to the terminal 30. By preparing the rendered image in advance, the rendering processing time from when the terminal 30 transmits the position information to when the image corresponding to the position information is displayed on the terminal 30 is unnecessary, and the calculation delay can be reduced.

When an optimal server (for example, the server closest to the terminal) performs rendering and image transmission, a communication distance is shortened, and a network delay from when the terminal transmits position information to when an image corresponding to the position information is displayed on the terminal can be reduced.

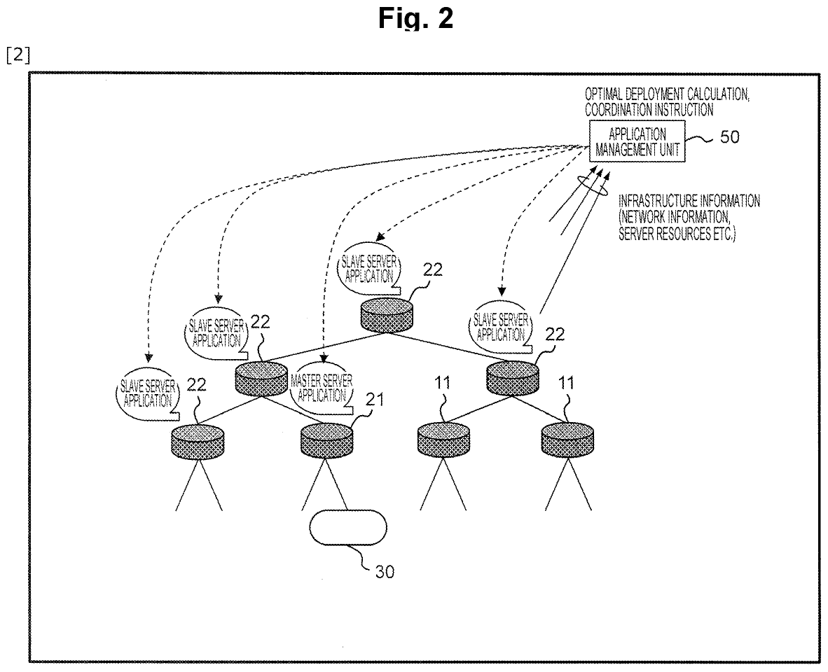

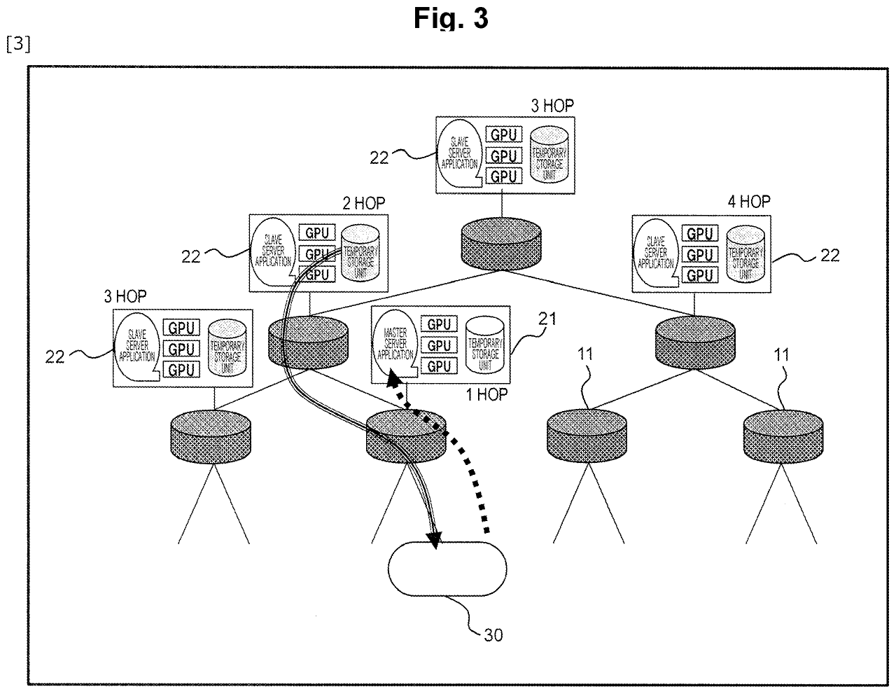

Selection of an optimal server in the present invention will be specifically described with reference to FIGS. 2 and 3. As illustrated in FIG. 2, the selection of the server 11 may be performed by an application management unit 50 (In the drawings, the “application management unit” is abbreviated as an “application management unit”). The application management unit 50 selects the server 11 with a low total cost (server use cost, network use cost, and the like) so as not to impair user experience and not to waste edge server resources while obtaining information about the entire infrastructure (network, server resources (central processing unit (CPU), memory, storage, GPU, and the like)) including a resource usage status by other terminals and other services using the application.

The remote rendering system also leverages the computation and temporary storage resources of another server that resides within a range that satisfies allowable delay of the application. A usable server will be described with reference to FIG. 3. For example, a case where the following conditions (1) to (3) are satisfied will be considered. (1) An allowable delay of the application is 18 ms. (2) The maximum time taken to retrieve and read an image from the temporary storage region is 10 ms. (3) A transmission or propagation delay per network path hop is 1 ms. Then, since (1 ms×4 (hops)×2 (round trip)+10 ms 18 ms) holds, the remote rendering system can use resources from the terminal 30 to the server 11 located at a maximum of 4 hops away.

The application management unit 50 considers not only simply selecting the server 11 (assumed to have a high server cost) closest to the terminal 30 so as to minimize the network delay, but also selecting the server 11 that is located at a remote location and has a low cost within a range satisfying the allowable delay as described above. The remote rendering system can use server resources at low cost while maintaining service quality (preventing VR sickness).

Furthermore, the server 11 existing within a range that satisfies the allowable delay of the application is selected according to the probability of being read most recently. For example, it is conceivable that an image corresponding to coordinates having a high probability of being read most recently is calculated by the server 11 closer to the terminal 30 and stored in a temporary storage region in the server 11. Since an image can be returned with a higher probability with a lower delay within the allowable delay range, the perceived quality is improved.

Furthermore, the allowable delay (budget of delay) is adjusted not only by selection of the far server 11 or the near server 11, but also by, for example, changing the encoding system. For example, in a case where there is a margin in the available bandwidth based on network available bandwidth information obtained by throughput guidance, radio network information (RNI), or the like, it is possible to expand the budget of the delay by changing a method to a compression method that requires a shorter encoding or decoding time in exchange for an increase in the use bandwidth.

### First Embodiment

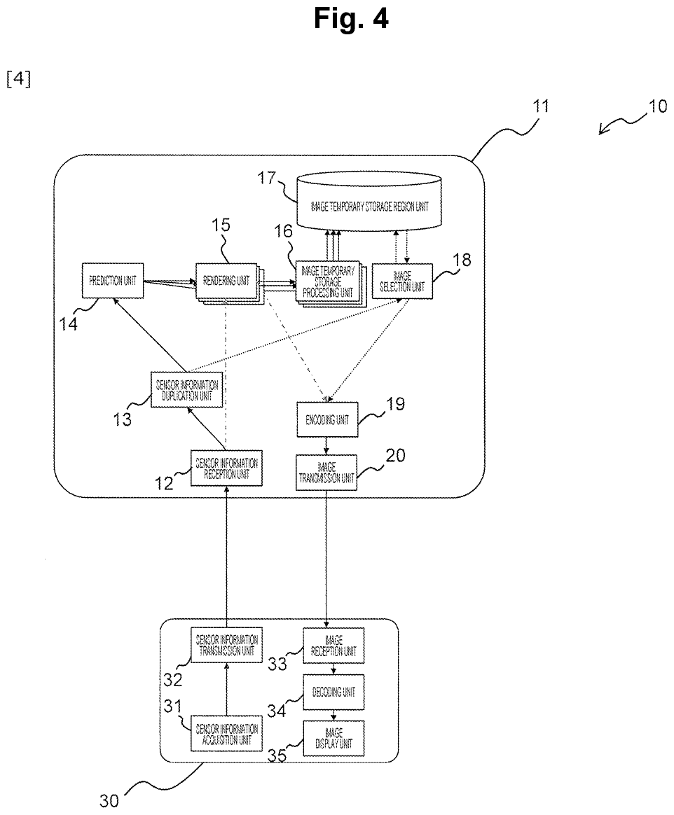

The configuration of the remote rendering system according to the present embodiment will be specifically described with reference to FIG. 4. A remote rendering system 10 includes a terminal 30 having a sensor, and a server 11, wherein the terminal 30 transmits sensor state information to the server 11, and the server 11 transmits a rendered image corresponding to the sensor state to the terminal 30.

The terminal 30 includes a sensor information acquisition unit 31, a sensor information transmission unit 32, an image reception unit 33, a decoding unit 34, and an image display unit 35. The terminal 30 may be a head mounted display.

The sensor information acquisition unit 31 acquires information about a current sensor state from a sensor included in the terminal 30. The sensor information transmission unit 32 transmits the acquired sensor state information to the server 11. In the transmission method, it is desirable to employ radio communication.

The image reception unit 33 receives the image transmitted from the server 11. In a reception method, it is desirable to employ radio communication. The decoding unit 34 converts the received image into a format that can be displayed on the terminal 30. The image display unit 35 displays the converted image.

The server 11 is a server device that transmits, to a terminal 30 having a sensor, a rendered image corresponding to a sensor state received from the terminal 30, wherein the server device includes a sensor information reception unit 12 that receives information about the current sensor state from the terminal 30, a prediction unit 14 that predicts a plurality of possibilities of the sensor state to be expected in an immediate future based on the received information about the current sensor state, a rendering unit 15 that performs rendering corresponding to the predicted possibilities of the sensor state, an image temporary storage processing unit 16 and an image temporary storage region unit 17 that function as a storage unit that stores a plurality of the rendered images generated by the rendering, an image selection unit 18 that selects the rendered image corresponding to the current sensor state from the plurality of rendered images stored in the storage unit, and an image transmission unit 20 that transmits the selected rendered image to the terminal 30. Furthermore, the server 11 may include a sensor information duplication unit 13 and an encoding unit 19.

The sensor information reception unit 12 receives the information about the current sensor state transmitted by the sensor information transmission unit 32. The sensor information duplication unit 13 duplicates the received information about the current sensor state into two, to transmit one to the prediction unit 14 and another one to the image selection unit 18.

The prediction unit 14 receives the current sensor state from the sensor information duplication unit 13. The prediction unit 14 predicts a plurality of possibilities of the sensor state to be expected in the immediate future based on the received information about the current sensor state. The method described in Non Patent Literature 2 may be used in order to perform the prediction. In addition, static prediction, an alpha beta gamma method, a Kalman filter, or the like may be used for the prediction. The prediction unit 14 transmits the predicted possibilities to the rendering unit 15.

The rendering unit 15 receives the possibilities of the sensor state from the prediction unit 14. The rendering unit 15 performs rendering corresponding to each of the received possibilities of the sensor state. In the rendering, a prediction technique such as a Kalman filter may be used. In addition, depending on the situation, only a specific sensor state may be narrowed down in advance, or an impossible sensor state may be excluded. For example, the sensor state may be narrowed down to the vicinity of the viewpoint of the seat in the case of a scene in which the user sits and uses the terminal (in the vehicle or the like), the sensor state may be narrowed down to the height of the line of sight of a person (near 1.5 m on the ground) in the case of a scene in which the user stands and uses the terminal. In addition, a viewpoint from the sky or a viewpoint from which a wall or the ground, which is impossible, may be excluded. By using the content of Non Patent Literature 3, the rendering unit 15 can reduce the load by not performing the rendering process for the viewpoint having a low probability of being read. Furthermore, the content of Non Patent Literature 3 can also be used as a determination criterion for the image temporary storage processing unit 16 to discard a pre-rendered image whose probability of being read most recently has decreased by a certain level or more. The rendering unit 15 transmits the rendered image to the image temporary storage processing unit 16.

The image temporary storage processing unit 16 and the image temporary storage region unit 17 each function as a storage unit. The image temporary storage processing unit 16 receives the rendered image and information about the corresponding possibility of the sensor state. The image temporary storage processing unit 16 temporarily stores the rendered image together with information about the corresponding possibility of the sensor state in the image temporary storage region unit 17. By using the content of Non Patent Literature 4, the image selection unit 18 can efficiently read an image rendered in advance.

The image selection unit 18 receives the current sensor state from the sensor information duplication unit 13. The image selection unit 18 searches for and selects a rendered image corresponding to the received current sensor state from the plurality of rendered images temporarily stored in the image temporary storage region unit 17. In a case where there is no rendered image corresponding to the current sensor state in the image temporary storage region unit 17, the image selection unit 18 may cause the rendering unit 15 to perform rendering for the current sensor state and select the created rendered image. Furthermore, in a case where there is no rendered image corresponding to the current sensor state in the image temporary storage region unit 17, and when an image cannot be newly created by rendering, the image selection unit 18 may use an existing technology (Time-Warp or the like), or may set the image to be selected to a blackish image. At the time of initial sensor information reception, when coordinate prediction cannot be performed in the future, or when resources for a plurality of parallel pre-rendering cannot be secured, processing similar to that in the case where there is no rendered image corresponding to the current sensor state in the image temporary storage region unit 17 may be performed. The image selection unit 18 transmits the selected image to the encoding unit 19.

The encoding unit 19 converts the received rendered image into a format for transmission. The image transmission unit 20 transmits the converted rendered image to the terminal 30.

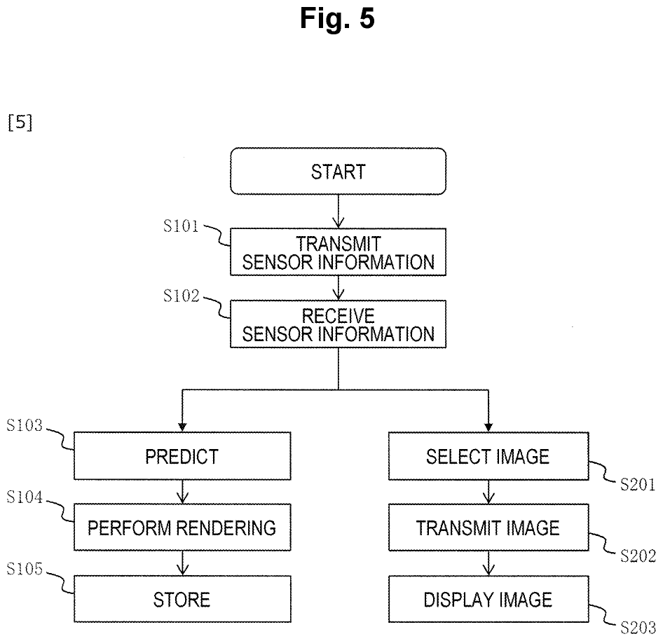

An example of the operation of the remote rendering system 10 is shown in FIG. 5. An image processing method of a remote rendering system 10 is an image processing method in which a terminal 30 having a sensor and a server 11 are included, the terminal 30 transmits information about a sensor state to the server 11, and the server 11 transmits a rendered image corresponding to the sensor state to the terminal 30, the method includes the terminal 30 transmitting information about a current sensor state to the server 11 (step S101), the server 11 predicting a plurality of possibilities of a sensor state to be expected in an immediate future based on the received information about the current sensor state (steps S102 and S103), performing rendering corresponding to the predicted possibilities of the sensor state (step S104), and storing a plurality of rendered images generated by the rendering (step S105).

It is desirable that the image processing method includes selecting, from the plurality of rendered images stored in the server 11 (step S201), a rendered image corresponding to the current sensor state, and further transmitting the selected rendered image to the terminal 30 (step S202). The image processing method includes, after step S202, the terminal 30 displaying the rendered image (step S203). Steps S103 to S105 and steps S201 to S203 may be performed in parallel, or either step may be performed first. Hereinafter, steps S101 to S105 and steps S201 to S203 will be described in detail.

(Step S101)

The sensor information transmission unit 32 transmits the sensor state information as described above.

(Step S102)

As described above, the sensor information reception unit 12 receives the sensor state information. As described above, the sensor information duplication unit 13 duplicates and transmits the sensor state information.

(Step S103)

As described above, the prediction unit 14 predicts possibilities of the sensor state to be expected in the immediate future.

(Step S104)

As described above, the rendering unit 15 performs rendering based on the possibilities of the sensor states.

(Step S105)

As described above, the image temporary storage processing unit 16 temporarily stores the rendered image and information about the corresponding possibilities of the sensor state in the image temporary storage region unit 17.

(Step S201)

As described above, the image selection unit 18 selects the rendered image corresponding to the current sensor state from the image temporary storage region unit 17.

(Step S202)

As described above, the encoding unit 19 encodes the rendered image, and the image transmission unit 20 transmits the rendered image.

(Step S203)

The image reception unit 33 receives the rendered image encoded as described above. The decoding unit 34 decodes the received rendered image. As described above, the image display unit 35 displays the decoded rendered image.

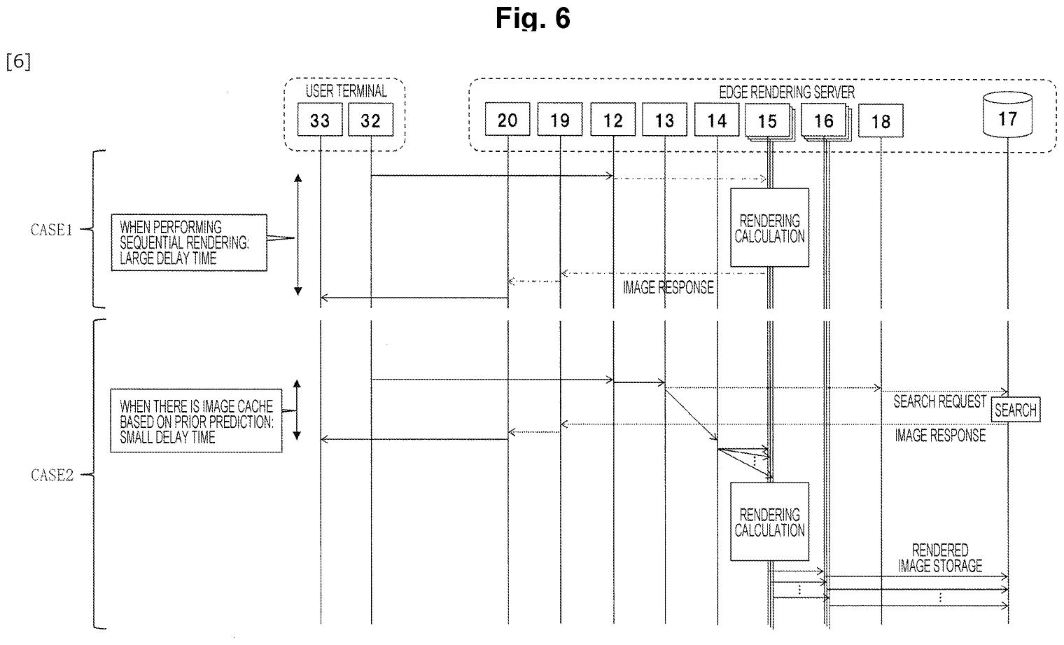

FIG. 6 illustrates an operational flow of the remote rendering system 10. CASE 1 illustrates an operation flow of sequentially performing rendering for the current sensor state without performing pre-rendering. In CASE 1, since the rendering unit 15 sequentially performs rendering after the information about the current sensor state is acquired, time for the rendering process is required before the rendered image is transmitted.

CASE 2 in FIG. 6 illustrates an operation flow in a case where pre-rendering is performed. The point of CASE 2 is that sensor information from the user terminal is duplicated in two by the sensor information duplication unit 13 in order to search for an image responding to the user and to predict coordinates that the user terminal can take in the immediate future. By duplicating the sensor information, search and prediction can be performed in parallel. By performing pre-rendering, and providing pre-rendered images, there is no need to perform the sequential rendering process according to the current sensor state, and the rendering processing time can be reduced.

The remote rendering system, the image processing method, and the server device according to the present disclosure can reduce a pre-rendering process and images generated by pre-rendering by pre-rendering an image only for a position (coordinates) to be expected in the immediate future. As a result, time and storage required for pre-rendering can be reduced.

As described above, the remote rendering system, the image processing method, and the server device according to the present disclosure can provide a remote rendering system, an image processing method, and a server device that can efficiently perform pre-rendering, reduce a delay in displaying an image to a user, and reduce a deviation between a line-of-sight direction of the user and a rendered image.

### Second Embodiment

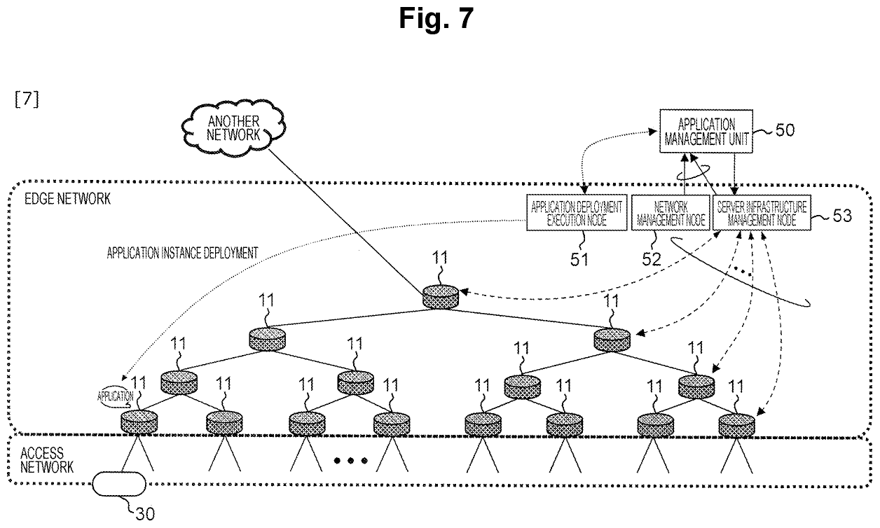

Hereinafter, an overall configuration of the remote rendering system 10 according to the present embodiment is illustrated in FIG. 7. The remote rendering system 10 includes a terminal 30, a plurality of servers 11, an application management unit 50 (in the drawing, the “application management unit” is abbreviated as an “application management unit”), an application deployment execution node 51, a network management node 52, and a server infrastructure management node 53.

The network management node 52 manages a network status between the servers 11 and a network status between the server 11 and the terminal 30, and reports the network status to the application management unit 50.

The server infrastructure management node 53 manages the infrastructure status of each server 11 and reports the infrastructure status to the application management unit 50. Examples of the infrastructure status of the server 11 include server resources such as a CPU, a memory, a storage, and a GPU.

The application management unit 50 will be described with reference to FIG. 2. The application management unit 50 selects servers 11 that are to perform rendering from among the plurality of servers 11 based on information reported from the network management node 52 and the server infrastructure management node 53, and designates one of the selected servers 11 as a master server 21 and others as the slave servers 22. The application management unit 50 causes the application deployment execution node 51 to deploy an appropriate application to the servers 11 designated as the master server 21 or the slave server 22. The application management unit 50 deploys the application to cause the selected server 11 to function as the master server 21 or the slave server 22. In a case where the network status or the infrastructure information has changed, the application management unit 50 may change the function of the server 11 by redeploying the application to which the change according to the change has been made. For example, consider a case where the server 11 closest to the position of the terminal 30 is set to the master server 21. In this case, when the position of the terminal 30 changes, a master server application may be deployed to the server 11 closest to the terminal 30 after the position change, instead of the server 11 that has functioned as the master server 21 so far, according to the change, to cause the server to function as the master server 21.

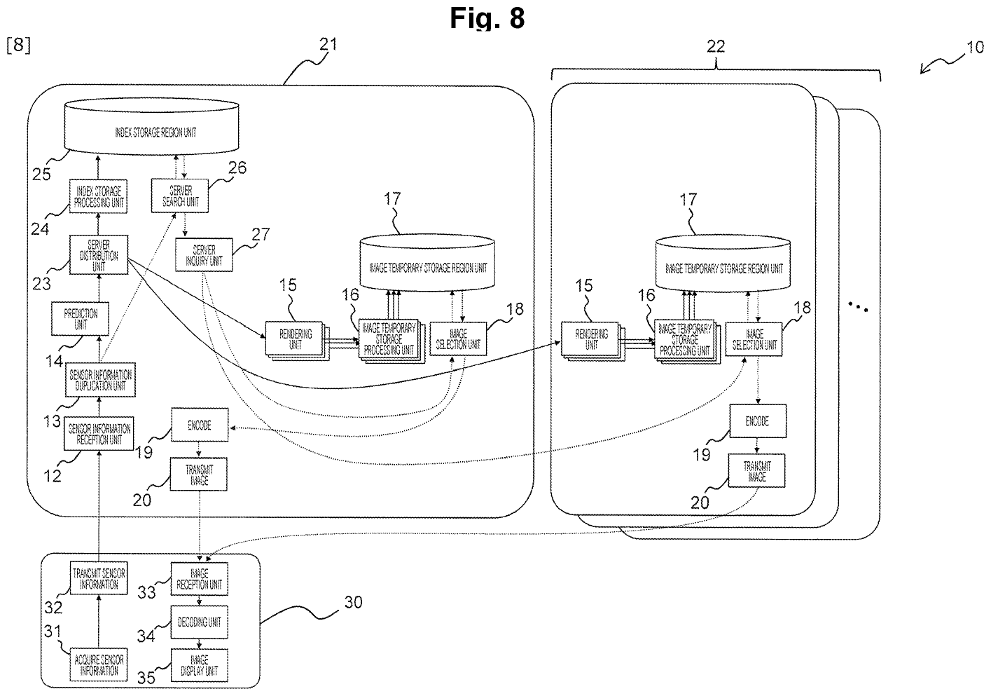

A configuration of terminal 30 will be described with reference to FIG. 8. The configuration of the terminal 30 is similar to that of the first embodiment. The sensor information transmission unit 32 transmits the acquired information about the current sensor state to the master server 21.

Configurations of the master server 21 and the slave server 22 will be described with reference to FIG. 8. The master server 21 includes a sensor information reception unit 12, a sensor information duplication unit 13, a prediction unit 14, a rendering unit 15, an image temporary storage processing unit 16, an image temporary storage region unit 17, an image selection unit 18, an encoding unit 19, an image transmission unit 20, a server distribution unit 23, an index storage processing unit 24, an index storage region unit 25, a server search unit 26, and a server inquiry unit 27. The sensor information reception unit 12, the image temporary storage processing unit 16, the image temporary storage region unit 17, the encoding unit 19, and the image transmission unit 20 are similar to those of the first embodiment.

The slave server 22 includes a rendering unit 15, an image temporary storage processing unit 16, an image temporary storage region unit 17, an image selection unit 18, an encoding unit 19, and an image transmission unit 20. The reference signs of the components of the slave server 22 correspond to the reference signs of the components of the master server 21, and the same components have the same contents.

Hereinafter, components of the master server 21 or the slave server 22 having functions different from those of the first embodiment and components to be newly added will be described. Specifically, the sensor information duplication unit 13, the prediction unit 14, the rendering unit 15, the image selection unit 18, the server distribution unit 23, the index storage processing unit 24, an index storage memory unit 25, the server search unit 26, and the server inquiry unit 27 will be described in detail.

The sensor information duplication unit 13 duplicates the received information about the current sensor state into two to transmit one to the prediction unit 14 and another one to the server search unit 26.

As in the first embodiment, the prediction unit 14 predicts a plurality of possibilities of a sensor state to be expected in the immediate future based on information about the current sensor state. The prediction unit 14 transmits the predicted possibilities to the server distribution unit 23.

The server distribution unit 23 receives the possibilities of the sensor states from the prediction unit 14. For each of the received possibilities of the sensor state, the master server 21 or the slave server 22 that is to perform rendering is selected. For example, the master server 21 or the slave server 22 is selectively used according to a probability that an image based on the predicted possibility (coordinates) is read most recently. It is conceivable that the image corresponding to the coordinate having a high probability of being read most recently is rendered by the master server 21 or the slave server 22 closer to the terminal 30 and stored in a temporary storage region in the server. The server distribution unit 23 transmits, to the selected master server 21 or slave server 22, the possibility of the sensor state on which the server is to perform rendering.

The rendering unit 15 receives the possibilities of the sensor state from the server distribution unit 23. As in the first embodiment, the rendering unit 15 performs rendering based on the received possibility of the sensor state to transmit the rendered image to the image temporary storage processing unit 16.

The index storage processing unit 24 temporarily stores, in the index storage region unit 25, title information (hereinafter, referred to as an “index”) serving as a key for searching for the image of the corresponding angle, such as information about “three-dimensional coordinates and orientation”, from the image temporary storage region unit 17. For example, the index may be a possibility of the sensor state and an ID of a server that performs rendering on the possibility. The index may be hashed for calculation efficiency.

The server search unit 26 searches for the index corresponding to the current sensor state in the index storage region unit 25, and selects the master server 21 or the slave server 22 holding the rendered image corresponding to the current sensor state.

The server inquiry unit 27 transmits the current sensor state to the image selection unit 18 of the master server 21 or the slave server 22 selected by the server search unit 26.

The image selection unit 18 receives the current sensor state from the server inquiry unit 27. As in the first embodiment, the image selection unit 18 selects the rendered image corresponding to the received current sensor state from the image temporary storage region unit 17 to transmit the selected image to the encoding unit 19.

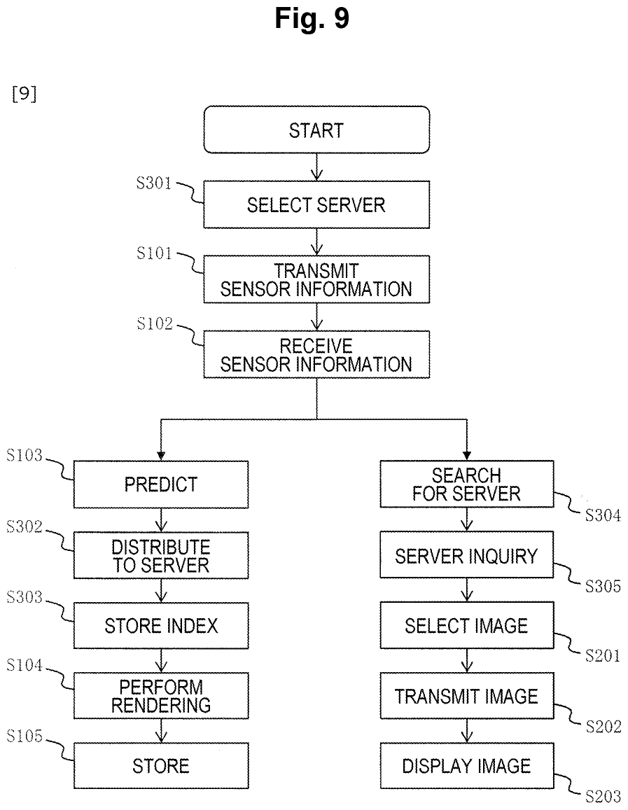

An example of the operation of the remote rendering system 10 is shown in FIG. 9. An image processing method of the remote rendering system 10 is an image processing method in which the terminal 30 having a sensor, the server 11, and the application management unit 50 are included, the terminal 30 transmits information about a sensor state to the server 11, and the server 11 transmits a rendered image corresponding to the sensor state to the terminal 30, wherein the method includes, in a case where there is a plurality of servers 11, selecting some of the plurality of servers 11, designating one of the selected servers 11 as the master server 21, and others as the slave server 22 (step S301), the terminal 30 transmitting information about a current sensor state to the master server 21 (step S101), the master server 21 predicting a plurality of possibilities of a sensor state to be expected in the immediate future (steps S102 and S103), at least one of the master server 21 and the slave server 22 performing rendering and storing a rendered image (steps S104 and S105). Furthermore, between step S103 and step S104, server distribution step S302 and index storage S303 may be performed.

After step S102, the image processing method may include searching for and selecting the master server 21 or the slave server 22 storing the rendered image corresponding to the current sensor state (step S304), and transmitting the current sensor state to the selected master server 21 or slave server 22 (step S305). It is desirable that after step S305, the image processing method includes selecting, from the plurality of rendered images stored in the master server 21 or the slave server 22, a rendered image corresponding to the current sensor state (step S201), and further transmitting the selected rendered image to the terminal 30 (step S202). Further, the image processing method includes, after step S202, the terminal 30 displaying the rendered image (step S203). Hereinafter, each step will be described in order. However, steps after step S103 and steps after step S304 may be performed in parallel or any of them may be performed first.

(Step S301)

As described above in the present embodiment, the application management unit 50 designates the master server 21 and the slave server 22.

(Step S101)

As described above in the present embodiment, the sensor information transmission unit 32 transmits the acquired sensor state information to the master server 21.

(Step S102)

The sensor information reception unit 12 receives information about the current sensor state, as in step S101 of the first embodiment. As described above in the present embodiment, the sensor information duplication unit 13 transmits the received information about the current sensor state to the prediction unit 14 and the server search unit 26.

(Step S103)

As described above in the present embodiment, the prediction unit 14 predicts possibilities of the sensor state to be expected in the immediate future.

(Step S302)

As described above in the present embodiment, the server distribution unit 23 selects the master server 21 or the slave server 22 that is to perform rendering to transmit the possibility of the sensor states.

(Step S303)

As described above in the present embodiment, the index storage processing unit 24 temporarily stores the index in the index storage region unit 25.

(Step S104)

The rendering unit 15 of the master server 21 or the slave server 22 selected in step S302 performs rendering based on the possibility of the sensor state as described above in the present embodiment. Steps S303 and S104 may be performed in parallel, or any of them may be performed first.

(Step S105)

The master server 21 or the slave server 22 selected in step S302 performs step S105 of the first embodiment.

(Step S304)

As described above in the present embodiment, the server search unit 26 selects the master server 21 or the slave server 22 that holds the rendered image corresponding to the current sensor state.

(Step S305)

As described above in the present embodiment, the server inquiry unit 27 transmits the current sensor state to the image selection unit 18 of the master server 21 or the slave server 22 selected in step S304.

(Step S201)

The image selection unit 18 of the master server 21 or the slave server 22 selected in step S304 selects the rendered image corresponding to the current sensor state from the image temporary storage region unit 17 as described above in the present embodiment.

(Step S202)

In the master server 21 or the slave server 22 selected in step S304, step S202 of the first embodiment is performed.

(Step S203)

The terminal 30 that has received the rendered image from the master server 21 or the slave server 22 selected in step S304 performs step S203 of the first embodiment.

As described above, the remote rendering system and the image processing method according to the present disclosure can effectively utilize the free resources of a plurality of servers by performing pre-rendering using the servers. In addition, by transmitting an image from a server in the vicinity of the terminal based on the position information about the terminal, a delay due to communication can be reduced.

### Third Embodiment

A program according to the present embodiment is a program for causing a computer to function as a server device. The server device can also be realized by a computer and a program, and the program can be recorded in a recording medium or provided through a network. The computer in which the program is installed functions as the server device described in FIGS. 4 and 8.

The above inventions can be combined as much as possible.

### INDUSTRIAL APPLICABILITY

The remote rendering system according to the present disclosure can be applied to the information communication industry.

### REFERENCE SIGNS LIST

10 remote rendering system
11 server
12 sensor information reception unit
13 sensor information duplication unit
14 prediction unit
15 rendering unit
16 image temporary storage processing unit
17 image temporary storage region unit
18 image selection unit
19 encoding unit
20 image transmission unit
21 master server
22 slave server
23 server distribution unit
24 index storage processing unit
25 index storage region unit
26 server search unit
27 server inquiry unit
30 terminal
31 sensor information acquisition unit
32 sensor information transmission unit
33 image reception unit
34 decoding unit
35 image display unit
50 application management unit
51 application deployment execution node
52 network management node
53 server infrastructure management node

1. A remote rendering system comprising:
a terminal having a sensor; and
a server, wherein
the terminal comprising one or more processors configured to: transmit information about a sensor state to the server and transmit information about a current sensor state to the server,
the server comprising one or more processors configured to: transmitting transmit a rendered image corresponding to the sensor state to the terminal,
predict a plurality of possibilities of the sensor state to be expected in an immediate future based on the received information about the current sensor state,
perform rendering corresponding to each of the predicted possibilities of the sensor state, and
store a plurality of the rendered images generated by the rendering.

2. The remote rendering system according to claim 1, further comprising:
an application server, wherein
in a case where there is a plurality of servers, the application server comprising one or more processors configured to: select some of the plurality of servers and designate one of the selected servers as a master server and others as slave servers,
the terminal is configured to transmit information about the current sensor state to the master server,
the master server comprising one or more processors configured to predict a plurality of possibilities of the sensor state to be expected in an immediate future, and
at least one of the master server and the slave servers are configured to perform the rendering based on the predicted possibilities of the sensor state, and store the rendered image.

3. The remote rendering system according to claim 1, wherein the server is configured to: select, from the plurality of stored rendered images, the rendered image corresponding to the current sensor state, and transmit the selected rendered image to the terminal.

4. An image processing method in which a terminal having a sensor and a server are included, the terminal configured to transmit information about a sensor state to the server, and the server configured to transmit a rendered image corresponding to the sensor state to the terminal, the method comprising:
transmitting information about a current sensor state from the terminal to the server;
predicting, by the server, a plurality of possibilities of the sensor state to be expected in an immediate future based on the received information about the current sensor state;
performing rendering corresponding to the predicted possibilities of the sensor state; and
storing a plurality of rendered images generated by the rendering.

5. The image processing method according to claim 4, further comprising:
in a case where there is a plurality of servers, selecting some of the plurality of servers and designating one of the selected servers as a master server and others as slave servers;
transmitting information about the current sensor state from the terminal to the master server;
predicting, by the master server, a plurality of possibilities of the sensor state to be expected in an immediate future; and
performing, by at least one of the master server and the slave servers, the rendering and storing the rendered image.

6. The image processing method according to claim 4, further comprising:
selecting, from the plurality of rendered images stored in the server, the rendered image corresponding to the current sensor state; and
transmitting the selected rendered image to the terminal.

7. A server device that transmits, to a terminal having a sensor, a rendered image corresponding to a sensor state received from the terminal, the server device comprising one or more processors configured to:
receive information about a current sensor state from the terminal;
predict a plurality of possibilities of the sensor state to be expected in an immediate future based on the received information about the current sensor state;
perform rendering corresponding to the predicted possibilities of the sensor state;
store a plurality of rendered images generated by the rendering;
select the rendered image corresponding to the current sensor state from the plurality of rendered images stored in a storage unit; and
transmit the selected rendered image to the terminal.

8. A program for causing a computer to function as the server device according to claim 7.
